(19) United States
(12) Patent Application Publication
(10) Pub. No.: US 2008/0155187 A1
(43) Pub. Date: Jun. 26, 2008

(54) System including memory buffer configured to decouple data rates

(76) Inventor: Maurizio Skerlj, Munich (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/642,307

(22) Filed: Dec. 20, 2006

(51) Int. Cl. G06F 12/00

(52) U.S. Cl. 711/105; 711/E12.001

(57) ABSTRACT

One embodiment provides a memory system including first dynamic random access memories and a first memory buffer. The first memory buffer is configured to receive southbound data at a first data rate and provide northbound data at a second data rate. The first memory buffer is also configured to read data from the first dynamic random access memories at a third data rate, wherein the first memory buffer is configured to decouple the third data rate from the first data rate and the second data rate.

### BACKGROUND

Typically, a computer system includes a number of integrated circuits that communicate with one another to perform system applications. Often, the computer system includes one or more host controllers and one or more electronic subsystem assemblies, such as memory modules, a graphics card, an audio card, a facsimile card, and a modem card.

The memory modules can be dual in-line memory modules (DIMMs) that include random access memory (RAM) chips, such as dynamic RAM (DRAM) chips. The DRAM can be any suitable type of DRAM including double data rate DRAM (DDR-DRAM) and double data rate synchronous DRAM (DDR-SDRAM). Also, the DRAM can be any suitable generation, such as first, second, and third generation DDR-SDRAM.

To perform system functions, the host controller(s) and subsystem assemblies communicate via communication links, such as serial communication links and parallel communications links. Serial communication links include links that implement the fully buffered DIMM (FB-DIMM) advanced memory buffer (AMB) standard or any other suitable serial communications link interface.

An AMB chip is a key device in an FB-DIMM. An AMB has two serial links, one for upstream traffic and the other for downstream traffic, and a memory bus to on-board memory, such as DRAM on the FB-DIMM. Serial data from a host controller or AMB sent through the downstream serial link (southbound) is temporarily buffered in an AMB and can then be sent to memory on the FB-DIMM. The southbound data contains the address, data, and command information given to the FB-DIMM, converted in the AMB, and sent to the memory bus. The AMB writes in and reads out data from the memory as instructed by the host controller. The read data is converted to serial data and sent back to the host controller on the upstream serial link (northbound).

An AMB also performs as a repeater between FB-DIMMs on the same memory channel. The AMB transfers information from a primary southbound link connected to the host controller or an upper AMB to a lower AMB in the next FB-DIMM via a secondary southbound link. The AMB receives information in the lower FB-DIMM from a secondary northbound link, and after merging the information with information of its own, sends it to the upper AMB or host controller via a primary northbound link. This forms a daisy-chain among FB-DIMMs. A key attribute of the FB-DIMM architecture is the high-speed, serial, point-to-point connection between the host controller and FB-DIMMs on the memory channel.

Typically, in an FB-DIMM system, the controller and the AMBs send southbound data at one data rate and receive northbound data at double the southbound data rate. This leads to a 1:2 write to read ratio, which reflects statistics in typical memory access patterns. On the FB-DIMM, the AMB is coupled to DRAMs via a standard DRAM interface. The DRAM interface consists of a stub-bus for the commands, addresses, and control signals and point-to-point or point-to-multiple points for data.

Data rates of the controller and the AMBs are coupled to the DRAM data rates. The northbound data rates are matched to the data rate of the DRAM interface. Further increases in data bandwidth can be obtained by increasing the bandwidth of all connections by the same amount. In this architecture, a faster controller and faster AMBs does not lead to a higher bandwidth, unless a higher bandwidth DRAM is available.

Although this architecture allocates enough bandwidth for sending up to three commands in each southbound frame, due to bandwidth matching of the northbound data rate and the DRAM interface it is only possible to read one FB-DIMM at a time. In systems having many FB-DIMMs per memory channel, several FB-DIMMs remain idle or in the best case only receive southbound data.

For these and other reasons there is a need for the present invention.

### SUMMARY

The present disclosure describes a memory system that includes one or more memory buffers configured to decouple the memory data rate from the southbound data rate and the northbound data rate. One embodiment provides a memory system including first dynamic random access memories and a first memory buffer. The first memory buffer is configured to receive southbound data at a first data rate and provide northbound data at a second data rate. The first memory buffer is also configured to read data from the first dynamic random access memories at a third data rate, wherein the first memory buffer is configured to decouple the third data rate from the first data rate and the second data rate.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated, as they become better understood by reference to the following detailed description. The elements of the drawings are not necessarily to scale relative to each other. Like reference numerals designate corresponding similar parts.

FIG. 1 is a block diagram illustrating one embodiment of an electrical system according to the present invention.

FIG. 2 is a diagram illustrating one embodiment of an advanced memory buffer.

FIG. 3 is a timing diagram illustrating the operation of one embodiment of an electrical system.

FIG. 4 is a timing diagram illustrating the operation of another embodiment of an electrical system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

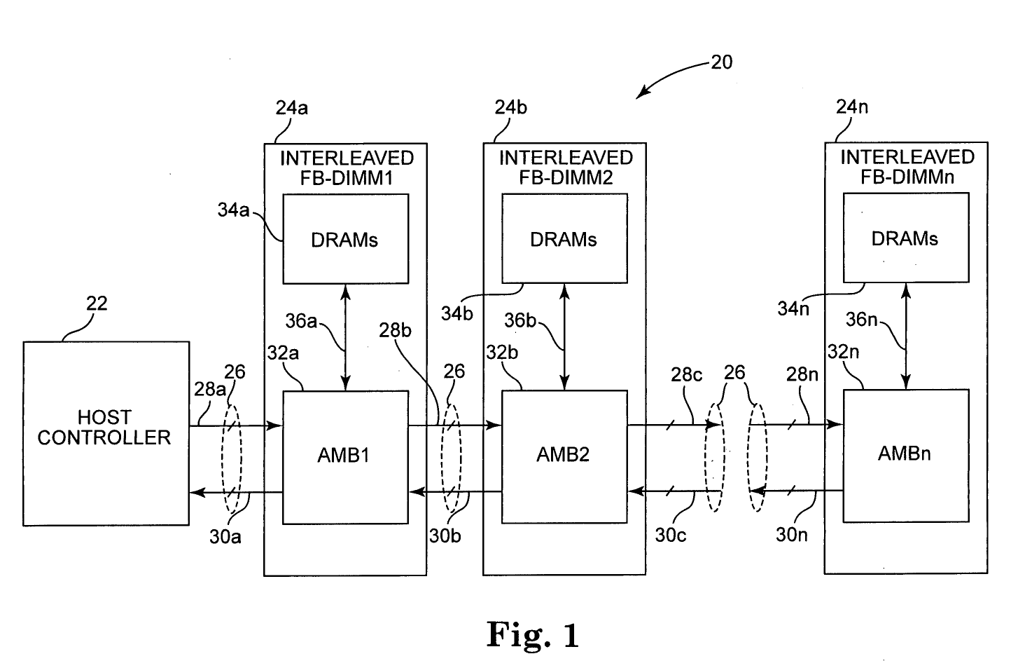

FIG. 1 is a block diagram illustrating one embodiment of an electrical system 20 according to the present invention. Electrical system 20 includes a host controller 22 and interleaved FB-DIMMs 24a-24n. Host controller 22 controls FB-DIMMs 24a-24n to provide system memory functions. FB-DIMMs 24a-24n are one type of subsystem assembly. In other embodiments, electrical system 20 includes host controller 22 and any other suitable subsystem assembly, such as a graphics card, an audio card, a facsimile card, or a modem card, and host controller 22 controls the subsystem assembly to provide corresponding system functions.

FB-DIMMs 24a-24n are daisy-chained together and coupled to host controller 22 via memory channel 26. FB-DIMMs 24a-24n receive southbound data at a southbound data rate via memory channel 26 and FB-DIMMs 24a-24n provide northbound data at a northbound data rate via memory channel 26. Each of the FB-DIMMs 24a-24n communicates with on-board memory at a memory data rate that is decoupled from the southbound data rate and the northbound data rate. Also, the memory data rate on one of the FBDIMMs 24a-24n can be different than the memory data rate on any of the other FB-DIMMs 24a-24n. In one embodiment, FB-DIMMs 24a-24n interleave data in the northbound data at the northbound data rate. In one embodiment, the southbound data rate is different than the northbound data rate and each of the memory data rates is the same or different than the southbound data rate and the northbound data rate.

As used herein, the term “electrically coupled” is not meant to mean that the elements must be directly coupled together and intervening elements may be provided between the “electrically coupled” elements.

FB-DIMMs 24a-24n are electrically coupled to host controller 22 via memory channel 26, which includes southbound data paths 28a-28n and northbound data paths 30a-30n. Host controller 22 is electrically coupled to FB-DIMM1 at 24a via southbound data path 28a and northbound data path 30a. FB-DIMM1 at 24a is electrically coupled to FB-DIMM2 at 24b via southbound data path 28b and northbound data path 30b. FB-DIMM2 at 24b is electrically coupled to the next FB-DIMM via southbound data path 28c and northbound data path 30c and so on, up to the previous FB-DIMM being electrically coupled to FB-DIMMn at 24n via southbound data path 28n and northbound data path 30n.

FB-DIMM1 at 24a includes AMB1 at 32a and DRAMs at 34a. FB-DIMM2 at 24b includes AMB2 at 32b and DRAMs at 34b and so on, up to FB-DIMMn at 24n that includes AMBn at 32n and DRAMs at 34n. DRAMs 34a-34b can be any suitable speed and/or type of DRAM including DDR-SDRAM. Also, DRAMs 34a-34b can be any suitable generation, such as first, second, and third generation DDR-SDRAM. In one embodiment, DRAMs at 34a are one speed of DRAM, DRAMs at 34b are another speed of DRAM, and DRAMs at 34n are a third speed of DRAM. In one embodiment, each of the FB-DIMMs at 24a-24n includes 18 DDR-SDRAM circuits. In one embodiment, each of the FB-DIMMs at 24a-24n includes any suitable number of DDR-SDRAM circuits.

AMB1 at 32a is electrically coupled to DRAMs at 34a via memory paths 36a and to host controller 22 via southbound data path 28a and northbound data path 30a. AMB2 at 32b is electrically coupled to DRAMs at 34b via memory paths 36b and to AMB1 via southbound data path 28b and northbound data path 30b. Also, AMB2 at 32b is electrically coupled to the next AMB via southbound data path 28c and northbound data path 30c. AMBn at 32n is electrically coupled to DRAMs at 34n via memory paths 36n and to the previous AMB via southbound data path 28n and northbound data path 30n.

Host controller 22 provides southbound data to FB-DIMM1 at 24a and AMB1 at 32a via southbound data path 28a. The southbound data includes commands, addresses, and data for controlling FB-DIMMs 24a-24n. The commands include activate, read, and write commands. The addresses include FB-DIMM addresses and DRAM read and write addresses. Data includes write data to be written into the DRAMs 34a-34n. In one embodiment, the commands include a put command for putting read data that was read from one or more DRAMs on one of the FB-DIMMs 24a-24n into the northbound data.

Host controller 22 receives northbound data from FB-DIMM1 at 24a and AMB1 at 32a via northbound data path 30a. The northbound data includes read data from the FB-DIMMs 24a-24n. Read data from multiple FB-DIMMs 24a-24n can be interleaved in the northbound data.

AMB1 at 32a receives southbound data from host controller 22 at the southbound data rate. AMB1 at 32a temporarily buffers the received southbound data. If AMB1 at 32a detects a command for FB-DIMM1 at 24a in the buffered southbound data, AMB1 at 32a provides the command to on-board DRAMs 34a via memory paths 36a. AMB1 at 32a writes data into and reads data out of addressed DRAMs 34a. The data written into and read out of the DRAMs 34a is communicated at the memory data rate of the DRAMs 34a over memory paths 36a. AMB1 at 32a temporarily buffers read data and then provides the read data in northbound data to host controller 22 at the northbound data rate. AMB1 at 32a decouples the memory data rate from the southbound data rate and the northbound data rate. In one embodiment, AMB1 at 32a provides the read data in northbound data to host controller 22 at the northbound data rate in response to a put command from host controller 22.

If the buffered southbound data is not addressed to FB-DIMM1 at 24a, AMB1 at 32a provides the buffered southbound data to FB-DIMM2 at 24b and AMB2 at 32b via southbound data path 28b. AMB1 at 32a receives northbound data from FB-DIMM2 at 24b and AMB2 at 32b via northbound data path 30b. The northbound data includes read data from the FB-DIMMs 24b-24n.

AMB2 at 32b receives southbound data from AMB1 at 32a at the southbound data rate. AMB2 at 32b temporarily buffers the received southbound data. If AMB2 at 32b detects a command for FB-DIMM2 at 24b in the buffered southbound data, AMB2 at 32b provides the command to on-board DRAMs 34b via memory paths 36b. AMB2 at 32b writes data into and reads data out of addressed DRAMs 34b. The data written into and read out of the DRAMs 34b is communicated at the memory data rate of the DRAMs 34b over memory paths 36b. AMB2 at 32b temporarily buffers read data and then provides the read data in northbound data to host controller 22 at the northbound data rate. AMB2 at 32b decouples the memory data rate from the southbound data rate and the northbound data rate. In one embodiment, AMB2 at 32b provides the read data in northbound data to host controller 22 at the northbound data rate in response to a put command from host controller 22.

If the buffered southbound data is not addressed to FB-DIMM2 at 24b, AMB2 at 32b provides the buffered southbound data to the next FB-DIMM and AMB via southbound data path 28c. AMB2 at 32b receives northbound data from the next FB-DIMM and AMB via northbound data path 30c. The northbound data includes read data from the FB-DIMMs 24c-24n. This forms a daisy-chain among FB-DIMMs 24a-24n up to FB-DIMMn at 24n.

FB-DIMMn at 24n and AMBn at 32n receives southbound data from the previous AMB at the southbound data rate via southbound data path 28n. AMBn at 32n temporarily buffers the received southbound data. If AMBn at 32n detects a command for FB-DIMMn at 24n in the buffered southbound data, AMBn at 32n provides the command to on-board DRAMs 34n via memory paths 36n. AMBn at 32n writes data into and reads data out of addressed DRAMs 34n. The data written into and read out of the DRAMs 34n is communicated at the memory data rate of the DRAMs 34n over memory paths 36n. AMBn at 32n temporarily buffers read data and then provides the read data in northbound data to host controller 22 at the northbound data rate. AMBn at 32n decouples the memory data rate from the southbound data rate and the northbound data rate. In one embodiment, AMBn at 32n provides the read data in northbound data to host controller 22 at the northbound data rate in response to a put command from host controller 22.

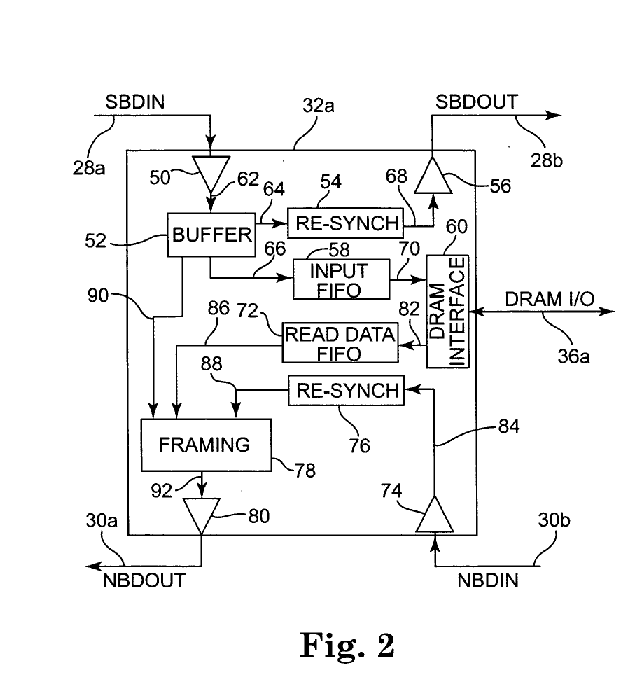

FIG. 2 is a diagram illustrating one embodiment of AMB1 at 32a. In one embodiment, each of the other AMBs 32b-32n is similar to AMB1 at 32a. In other embodiments, each of the other AMBs 32b-32n can be any suitable type or types of AMB.

AMB1 at 32a includes a southbound input circuit 50, a southbound (control circuit) input buffer 52, a southbound re-synchronization circuit 54, a southbound output circuit 56, an input first-in-first-out (FIFO) 58, and a DRAM interface circuit 60. Southbound input circuit 50 is electrically coupled to southbound input buffer 52 via buffer input path 62. Southbound input buffer 52 is electrically coupled to southbound re-synchronization circuit 54 via buffer output path 64 and to input FIFO 58 via FIFO input path 66. Southbound re-synchronization circuit 54 is electrically coupled to southbound output circuit 56 via re-synchronized data path 68. Input FIFO 58 is electrically coupled to DRAM interface circuit 60 via FIFO output path 70.

AMB1 at 32a and southbound input circuit 50 receive input southbound data SBDIN at 28a at the southbound data rate via southbound data path 28a. The input southbound data SBDIN at 28a includes the commands, addresses, and data for controlling FB-DIMMs 24a-24n. The commands include activate, read, write, and put commands.

Southbound input circuit 50 provides the input southbound data SBDIN at 28a to southbound input buffer 52 via buffer input path 62. Southbound input buffer 52 temporarily buffers the received input southbound data SBDIN. If AMB1 at 32a and southbound input buffer 52 detect a command for FB-DIMM1 at 24a in the input southbound data SBDIN, southbound input buffer 52 provides the command, corresponding addresses and, if applicable, write data to input FIFO 58 via FIFO input path 66. Input FIFO 58 provides the command, corresponding addresses and, if applicable, write data to DRAM interface circuit 60 via FIFO output path 70. DRAM interface circuit 60 provides the command, corresponding addresses and, if applicable, write data to on-board DRAMs 34a via memory paths 36a. The on-board DRAMs 34a respond to the received command, such as by writing the write data into DRAMs 34a or reading out read data from DRAMs 34a. The data written into and read out of DRAMs 34a is communicated at the memory data rate of DRAMs 34a over memory paths 36a. The memory data rate is decoupled from the southbound data rate via circuits such as southbound input buffer 52, input FIFO 58, and DRAM interface circuit 60.

If AMB1 at 32a and southbound input buffer 52 do not detect a command, address or data for FB-DIMM1 at 24a in the input southbound data SBDIN, southbound input buffer 52 provides the input southbound data to southbound re-synchronization circuit 54 via buffer output path 64. Southbound re-synchronization circuit 54 re-synchronizes the input southbound data to the southbound data and southbound data rate and provides the re-synchronized southbound data to southbound output circuit 56 via re-synchronized data path 68. Southbound output circuit 56 provides the re-synchronized southbound data as output southbound data SBDOUT at 28b via southbound data path 28b.

AMB1 at 32a includes a read data FIFO 72, a northbound input circuit 74, a northbound re-synchronization circuit 76, a framing circuit 78, and a northbound output circuit 80. DRAM interface circuit 60 is electrically coupled to read data FIFO 72 via read data path 82. Northbound input circuit 74 is electrically coupled to northbound re-synchronization circuit 76 via northbound data input path 84. Framing circuit 78 is electrically coupled to read data FIFO 72 via FIFO output path 86, to northbound re-synchronization circuit 76 via re-synchronized data path 88, and to southbound input buffer 52 via put command path 90. Also, framing circuit 78 is electrically coupled to northbound output circuit 80 via output data path 92.

DRAM interface 60 receives data read from DRAMs 34a at the memory data rate via memory paths 36a. DRAM interface 60 provides the read data to read data FIFO 72 via read data path 82. Read data FIFO 72 buffers the read data.

Northbound input circuit 74 receives input northbound data NBDIN at 30b via northbound data path 30b. The input northbound data NBDIN at 30b includes read data from FB-DIMMs 24b-24n. Northbound input circuit 74 provides the received input northbound data NBDIN at 30b to northbound re-synchronization circuit 76 via northbound data input path 84. Northbound re-synchronization circuit 76 resynchronizes the input northbound data NBDIN to northbound data and the northbound data rate. Framing circuit 78 receives the re-synchronized northbound data from northbound re-synchronization circuit 76 via re-synchronized data path 88. Framing circuit 78 provides the re-synchronized northbound data to northbound output circuit 80 via output data path 92. Northbound output circuit 80 provides re-synchronized northbound data as output northbound data NBDOUT at 30a at the northbound data rate via northbound data path 30a.

Framing circuit 78 receives a put command from southbound input buffer 52 via put command path 90 and read data FIFO 72 provides the read data to framing circuit 78 via FIFO output path 86. In response to the put command, framing circuit 78 inserts the read data into the northbound data that is provided to northbound output circuit 80 via output data path 92. Northbound output circuit 80 provides the northbound data as output northbound data NBDOUT at 30a at the northbound data rate via northbound data path 30a. The memory data rate is decoupled from the northbound data rate via circuits, such as DRAM interface 60, read data FIFO 72, and framing circuit 78. AMB1 at 32a decouples the memory data rate from the southbound data rate and the northbound data rate. In one embodiment, framing circuit 78 does not receive put commands and framing circuit 78 inserts the read data into the northbound data at the northbound data rate in response to the previous read command.

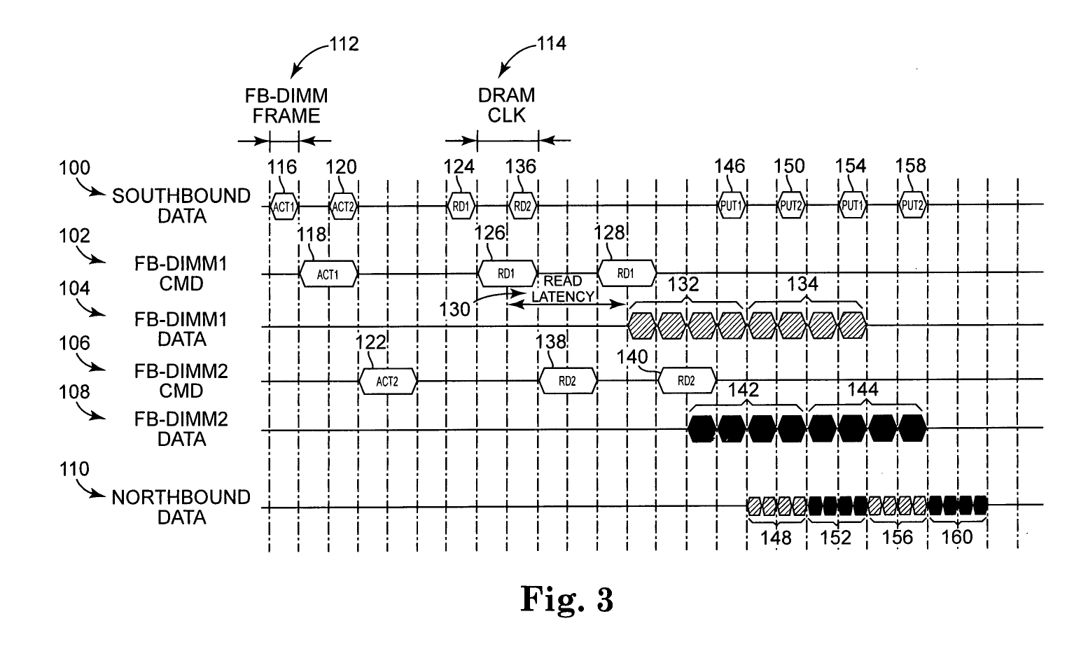

FIG. 3 is a timing diagram illustrating the operation of one embodiment of electrical system 20. Host controller 22 provides commands in southbound data at 100 to FB-DIMMs at 24a-24n via southbound data paths 28a-28n. FB-DIMM1 at 24a receives the southbound commands and provides FB-DIMM1 commands at 102 to DRAMs 34a. The DRAMs 34a provide FB-DIMM1 data at 104. FB-DIMM2 at 24b receives the southbound commands and provides FB-DIMM2 commands at 106 to DRAMs 34b. The DRAMs 34b provide FB-DIMM2 data at 108. FB-DIMM1 at 24a and FB-DIMM2 at 24b provide data in northbound data at 110, which is transmitted back to host controller 22 via northbound data paths 30a-30n.

In this example, the memory data rate between each of the AMBs 32a-32n and corresponding DRAMs 34a-34n is equal to each of the other memory data rates between the other AMBs 32a-32n and DRAMs 34a-34n. Also, the memory data rate is one half the northbound data rate. Since, accessing DRAMs 34a-34n at the memory data rate is independent of or decoupled from the northbound data rate, DRAMs 34a-34n on different FB-DIMMs 24a-24n can be accessed in parallel. Host controller 22 provides up to three commands in each of the southbound FB-DIMM frames 112. FB-DIMMs 24a-24n provide one command in each of the DRAM clock periods 114.

At 116, host controller 22 provides an activate command for FB-DIMM1 at 24a in southbound data at 100. FB-DIMM1 at 24a receives the activate command and at 118 provides an activate command to DRAMs 34a. This activates addressed DRAMs 34a. At 120, host controller 22 provides an activate command for FB-DIMM2 at 24b in southbound data at 100. FB-DIMM2 at 24b receives the activate command and at 120 provides an activate command to DRAMs 34b. This activates addressed DRAMs 34b.

At 124, host controller 22 provides a read command for FB-DIMM1 at 24a in southbound data at 100. FB-DIMM1 at 24a receives the read command and at 126 provides a first read command to DRAMs 34a and at 128 provides a second read command to DRAMs 34a. After read latency period 130, DRAMs 34a provide four blocks of data in four frames at 132 in response to the first read command. Also, after a read latency period DRAMs 34a provide four blocks of data in four frames at 134 in response to the second read command.

At 136, host controller 22 provides a read command for FB-DIMM2 at 24b in southbound data at 100. FB-DIMM2 at 24b receives the read command and at 138 provides a first read command to DRAMs 34b and at 140 provides a second read command to DRAMs 34b. After a read latency period, DRAMs 34b provide four blocks of data in four frames at 142 in response to the first read command. Also, after a read latency period DRAMs 34b provide four blocks of data in four frames at 144 in response to the second read command.

At 146, host controller 22 provides a put command for FB-DIMM1 at 24a in southbound data at 100. FB-DIMM1 at 24a receives the put command and inserts the four blocks of data at 132 into two frames at 148 of northbound data 110. At 150, host controller 22 provides a put command for FB-DIMM2 at 24b in southbound data at 100. FB-DIMM2 at 24b receives the put command and inserts the four blocks of data at 142 into two frames at 152 of northbound data 110. At 154, host controller 22 provides a put command for FB-DIMM1 at 24a in southbound data at 100. FB-DIMM1 at 24a receives the put command and inserts the four blocks of data at 134 into two frames at 156 of northbound data 110. At 158, host controller 22 provides a put command for FB-DIMM2 at 24b in southbound data at 100. FB-DIMM2 at 24b receives the put command and inserts the four blocks of data at 144 into two frames at 160 of northbound data 110.

Host controller 22 and FB-DIMMs 24a and 24b interleave the read data from FB-DIMMs 24a and 24b in northbound data at 110. In one embodiment of electrical system 20 with uniform memory data rates, the AMBs 32a-32n are programmed to insert the read data in northbound data traffic after a period of time in response to the read command from host controller 22, and without receiving a put command.

The degrees of freedom provided by electrical system 20 can be used to reduce latency times. Also, the degrees of freedom provided by electrical system 20 can be used to save power in systems where the northbound data rate is matched to a high data rate.

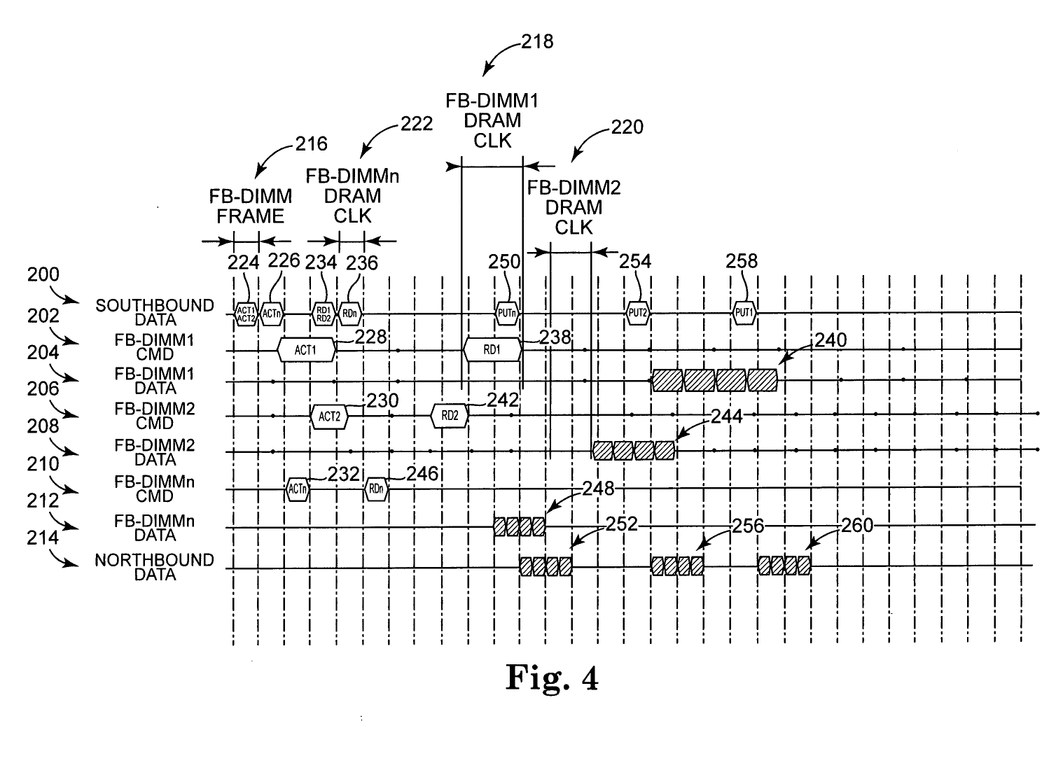

FIG. 4 is a timing diagram illustrating the operation of one embodiment of electrical system 20. Host controller 22 provides commands in southbound data at 200 to FB-DIMMs at 24a-24n via southbound data paths 28a-28n. FB-DIMM1 at 24a receives the southbound commands and provides FB-DIMM1 commands at 202 to DRAMs 34a. The DRAMs 34a provide FB-DIMM1 data at 204. FB-DIMM2 at 24b receives the southbound commands and provides FB-DIMM2 commands at 206 to DRAMs 34b. The DRAMs 34b provide FB-DIMM2 data at 208. FB-DIMMn at 24n receives the southbound commands and provides FB-DIMMn commands at 210 to DRAMs 34n. The DRAMs 34b provide FB-DIMMn data at 212. FB-DIMM1 at 24a, FB-DIMM2 at 24b, and FB-DIMMn at 24n provide data in northbound data at 214, which is transmitted back to host controller 22 via northbound data paths 30a-30n.

In this example, the memory data rate between each of the AMBs 32a-32n and corresponding DRAMs 34a-34n is different from each of the other memory data rates between the other AMBs 32a-32n and DRAMs 34a-34n. Since, accessing DRAMs 34a-34n at the memory data rate is independent of or decoupled from the northbound data rate, DRAMs 34a-34n on different FB-DIMMs 24a-24n can be accessed in parallel. Host controller 22 provides up to three commands in each of the southbound FB-DIMM frames 216. FB-DIMM1 at 24a provides one command in each of the DRAM clock periods 218. FB-DIMM2 at 24b provides one command in each of the DRAM clock periods 220. FB-DIMMn at 24n provides one command in each of the DRAM clock periods 222.

At 224, host controller 22 provides an activate command for FB-DIMM1 at 24a and an activate command for FB-DIMM2 at 24b in southbound data at 200. At 226, host controller 22 provides an activate command for FB-DIMMn at 24n in southbound data at 200. FB-DIMM1 at 24a receives the activate command and at 228 provides an activate command to DRAMs 34a, which activates addressed DRAMs 34a. FB-DIMM2 at 24b receives the activate command and at 230 provides an activate command to DRAMs 34b, which activates addressed DRAMs 34b. FB-DIMMn at 24n receives the activate command and at 232 provides an activate command to DRAMs 34n, which activates addressed DRAMs 34n.

At 234, host controller 22 provides a read command for FB-DIMM1 at 24a and a read command for FB-DIMM2 at 24b in southbound data at 200. At 236, host controller 22 provides a read command for FB-DIMMn at 24n in southbound data at 200. FB-DIMM1 at 24a receives the read command and at 238 provides a read command to DRAMs 34a. After a read latency period, DRAMs 34a provide four blocks of data at 240 in response to the read command. FB-DIMM2 at 24b receives the read command and at 242 provides a read command to DRAMs 34b. After a read latency period, DRAMs 34b provide four blocks of data at 244 in response to the read command. FB-DIMMn at 24n receives the read command and at 246 provides a read command to DRAMs 34n. After a read latency period, DRAMs 34n provide four blocks of data at 248 in response to the read command.

DRAMs 34n provide the four blocks of data at 248 at a higher memory data rate than the memory data rates that DRAMs 34a provide the four blocks of data at 240 and DRAMS 34b provide the four blocks of data at 244. DRAMs 34b provide the four blocks of data at 244 at a higher memory data rate than the memory data rate that DRAMs 34a provide the four blocks of data at 240. The four blocks of data at 248 are available before the four blocks of data at 244, which are available before the four blocks of data at 240.

At 250, host controller 22 provides a put command for FB-DIMMn at 24n in southbound data at 200. FB-DIMMn at 24n receives the put command and inserts the four blocks of data at 248 into two frames at 252 of northbound data 214. At 254, host controller 22 provides a put command for FB-DIMM2 at 24b in southbound data at 200. FB-DIMM2 at 24b receives the put command and inserts the four blocks of data at 244 into two frames at 256 of northbound data 214. At 258, host controller 22 provides a put command for FB-DIMM1 at 24a in southbound data at 200. FB-DIMM1 at 24a receives the put command and inserts the four blocks of data at 240 into two frames at 260 of northbound data 214.

In this example, electrical system 20 operates with DRAMs 34a-34n that do not have uniform speed grades. Electrical systems without uniform speed grades in DRAMs 34a-34n allow a more complex trade off between power consumption, DRAM capacity, DRAM speed grades, and system cost. Also, DRAMs with lower speed grades are usually available sooner than DRAMs with higher speed grades and systems that are already built with lower speed grades can be expanded in capacity and performance improved via higher speed grade DRAMs.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A memory system comprising:
first dynamic random access memories; and
a first memory buffer configured to receive southbound data at a first data rate and provide northbound data at a second data rate and to read data from the first dynamic random access memories at a third data rate, wherein the first memory buffer is configured to decouple the third data rate from the first data rate and the second data rate.

2. The memory system of claim 1, wherein the first memory buffer is configured to receive a put command in southbound data at the first data rate and provide read data in northbound data at the second data rate in response to the put command.

3. The memory system of claim 1, wherein the first memory buffer is configured to receive a read command in southbound data at the first data rate and to read data from one of the first dynamic random access memories at the third data rate in response to the read command.

4. The memory system of claim 1, wherein the first data rate is different than the second data rate.

5. The memory system of claim 1, wherein the third data rate is different than the first data rate and the second data rate.

6. The memory system of claim 1, comprising:
second dynamic random access memories; and
a second memory buffer configured to receive southbound data at the first data rate and provide northbound data at the second data rate and to read data from the second dynamic random access memories at a fourth data rate, wherein the second memory buffer is configured to decouple the fourth data rate from the first data rate and the second data rate.

7. The memory system of claim 6, wherein the fourth data rate is different than the third data rate.

8. The memory system of claim 6, wherein the fourth data rate is different than the first data rate and the second data rate.

9. The memory system of claim 8, wherein the fourth data rate is different than the third data rate.

10. An electrical system comprising:
a controller; and
first fully buffered dual in-line memory modules coupled to a first memory channel of the controller, wherein one of the first fully buffered dual in-line memory modules includes:
first dynamic random access memories; and
a first memory buffer configured to receive southbound data at a first data rate and provide northbound data at a second data rate and to read data from the first dynamic random access memories at a third data rate, wherein the first memory buffer is configured to decouple the third data rate from the first data rate and the second data rate.

11. The electrical system of claim 10, wherein another of the first fully buffered dual in-line memory modules includes:
second dynamic random access memories; and
a second memory buffer configured to receive southbound data at the first data rate and provide northbound data at the second data rate and to read data from the second dynamic random access memories at a fourth data rate, wherein the second memory buffer is configured to decouple the fourth data rate from the first data rate and the second data rate.

12. The electrical system of claim 11, wherein the first data rate is different than the second data rate.

13. The electrical system of claim 11, wherein the fourth data rate is different than the third data rate.

14. The electrical system of claim 11, wherein the third data rate is different than the first data rate and the second data rate, and the fourth data rate is different than the first data rate and the second data rate.

15. The electrical system of claim 11, comprising second fully buffered dual in-line memory modules coupled to a second memory channel of the controller.

16. A memory system comprising:
means for receiving southbound data at a first data rate;
means for providing northbound data at a second data rate;
means for reading data from first dynamic random access memories at a third data rate; and
means for decoupling the third data rate from the first data rate and the second data rate.

17. The memory system of claim 16, comprising:
means for receiving a put command in southbound data at the first data rate; and
means for providing read data in northbound data at the second data rate in response to the put command.

18. The memory system of claim 16, comprising:
means for receiving a read command in southbound data at the first data rate; and
means for reading data from one of the first dynamic random access memories at the third data rate in response to the read command.

19. The memory system of claim 16, wherein the first data rate is different than the second data rate and the third data rate is different than the first data rate and the second data rate.

20. The memory system of claim 16, comprising:
means for reading data from second dynamic random access memories at a fourth data rate; and
means for decoupling the fourth data rate from the first data rate and the second data rate.

21. The memory system of claim 20, wherein the fourth data rate is different than the third data rate.

22. A method of reading data in a memory system, comprising:
receiving southbound data at a first data rate;
providing northbound data at a second data rate;
reading data from first dynamic random access memories at a third data rate; and
decoupling the third data rate from the first data rate and the second data rate.

23. The method of claim 22, comprising:
receiving a put command in southbound data at the first data rate; and
providing read data in northbound data at the second data rate in response to the put command.

24. The method of claim 22, comprising:
receiving a read command in southbound data at the first data rate; and
reading data from one of the first dynamic random access memories at the third data rate in response to the read command.

25. The method of claim 22, comprising:
reading data from second dynamic random access memories at a fourth data rate; and
decoupling the fourth data rate from the first data rate and the second data rate.

26. The method of claim 25, wherein reading data from the second dynamic random access memories, comprises:
reading data from second dynamic random access memories at the fourth data rate that is different than the third data rate.

27. A method of reading data in an electrical system, comprising:
communicating southbound data and northbound data to a first memory buffer via a first memory channel;
receiving the southbound data at a first data rate at the first memory buffer;
providing the northbound data at a second data rate from the first memory buffer;
reading data from first dynamic random access memories at a third data rate via the first memory buffer; and
decoupling the third data rate from the first data rate and the second data rate.

28. The method of claim 27, comprising:
communicating southbound data and northbound data to a second memory buffer via the first memory channel;
receiving the southbound data at the first data rate at the second memory buffer;
providing the northbound data at the second data rate from the second memory buffer;
reading data from second dynamic random access memories at a fourth data rate via the second memory buffer; and
decoupling the fourth data rate from the first data rate and the second data rate.

29. The method of claim 28, comprising:
communicating southbound data and northbound data via a second memory channel to a third memory buffer.
